(19) United States
(12) Patent Application Publication
(10) Pub. No.: US 2026/0152440 A1
(43) Pub. Date: Jun. 4, 2026

(54) COMPOSITE WALLBOARD AND A PREPARATION METHOD THEREOF

(71) Applicants: CHINA STATE CONSTRUCTION HAILONG TECHNOLOGY COMPANY LIMITED, Shenzhen (CN); HARBIN INSTITUTE OF TECHNOLOGY, Harbin (CN); GUANGDONG HAILONG CONSTRUCTION TECHNOLOGY CO., LTD., Zhuhai (CN)

(72) Inventors: Baojun ZHAO, Shenzhen (CN); Xiaodong HE, Harbin (CN); Liping SHI, Harbin (CN); Xiaoguang WANG, Shenzhen (CN); Xiaoliang MA, Shenzhen (CN); Yesheng ZHONG, Harbin (CN); Wenqi ZHANG, Zhuhai (CN); Han YANG, Zhuhai (CN); Yangyu FU, Zhuhai (CN); Weilai ZENG, Shenzhen (CN); Zongjun ZHANG, Shenzhen (CN); Qiong WANG, Shenzhen (CN)

(73) Assignees: CHINA STATE CONSTRUCTION HAILONG TECHNOLOGY COMPANY LIMITED, Shenzhen (CN); HARBIN INSTITUTE OF TECHNOLOGY, Harbin (CN); GUANGDONG HAILONG CONSTRUCTION TECHNOLOGY CO., LTD., Zhuhai (CN)

(21) Appl. No.: 19/361,050

(22) Filed: Oct. 17, 2025

(30) Foreign Application Priority Data
Nov. 29, 2024 (CN) 202411735592.1

(51) Int. Cl. C04B 28/14; B28B 19/00; C04B 14/42; C04B 14/46; C04B 22/10; C04B 22/16; C04B 24/06; C04B 24/16; C04B 24/42; C04B 40/00; C04B 103/20; C04B 111/00

(52) U.S. Cl. CPC C04B 28/14; C04B 14/42; C04B 14/46; C04B 22/10; C04B 22/16; C04B 24/06; C04B 24/16; C04B 24/42; C04B 40/0067; B28B 19/0092; C04B 2103/20; C04B 2111/0062

(57) ABSTRACT

Provided is a composite wallboard and a preparation method thereof. The composite wallboard is prepared from raw materials. The raw materials include in parts by mass: 700 to 800 parts of calcined gypsum powder, 0.1 to 1.0 part of a retarder, 0.3 to 0.5 part of a foaming agent, 50 to 70 parts of inorganic fiber, 600 to 700 parts of water, 200 to 400 parts of a binder, 20 to 30 parts of a hydrophobic agent, 3 to 5 parts of an acid agent, and 3 to 5 parts of a pH regulator.

### CROSS-REFERENCE TO THE RELATED APPLICATIONS

This application claims priority to Chinese patent application No. 202411735592.1 filed on Nov. 29, 2024, the entire contents of which are incorporated herein by reference.

### TECHNICAL FIELD

The present disclosure relates to the technical field of lightweight wallboard materials, in particular to a composite wallboard and a preparation method thereof.

### BACKGROUND

A lightweight partition wall is mainly assembled from materials such as a keel, a thermal insulation board, a fireproof board, and a decorative material. Generally, a thermal insulation material (e.g., a basalt fiber board) is stuffed into the cavity inside the keel to meet the thermal insulation performance of the wall. Panels on both sides of the keel (usually fireproof gypsum boards) are fixed by self-tapping screws, generally, using gypsum boards, calcium silicate boards, and the like. If the partition wall has waterproof performance requirements, it is needed to add a waterproof layer; and finally, the decorative layer is installed. In order to meet various performance requirements, traditional partition walls need to use dry hanging to assemble wall panels with different performances. The construction process is tedious, the overall weight and thickness of the wall are large, secondary decoration processing needs to be performed on the surface of the wall, and the installation efficiency is low.

For the situation where the partition wall has waterproof performance requirements, a waterproof layer needs to be added. At present, waterproof plates, waterproof coatings, and the like are usually used for waterproof layers of the partition wall. The traditional waterproof plates and waterproof coatings do not have fireproof performance. Meanwhile, when one side of the wall is burnt by fire, crystallized water inside the gypsum board which is used as a fireproof plate, evaporates, and the temperature inside rises rapidly after evaporation of the crystallized water is completed, causing the basalt fiber board as a heat preservation material to melt, the fireproof and heat preservation capability is low, and corresponding potential safety hazards exist.

At present, the most widely used material for fireproofing of partition walls is gypsum board. However, the non-waterproofness of gypsum board may cause problems such as mold, expansion, or deterioration of gypsum products, so the water resistance of gypsum board is an important factor affecting the durability of gypsum board. Currently, the most common method of using gypsum is to use a hydrophobic agent to perform surface treatment on gypsum, but such a treatment will only make the surface of the gypsum have waterproof performance, while the interior of the substrate material still has no waterproof function. The main problem of adding the waterproof agent directly in the gypsum preparation process is that it affects the pH of the gypsum slurry, resulting in that the gypsum slurry cannot be solidified. At present, there are also related patents that adjust the pH of the gypsum slurry by adding a regulator, but those regulator materials added are all organic materials, which weaken the fireproof performance of gypsum which is used as a fireproof material.

Therefore, it is necessary to provide a composite wallboard and a preparation method thereof to improve the thermal insulation, hydrophobic and fireproof performance of the composite wallboard.

### SUMMARY

The embodiments in the present disclosure provide a composite wallboard, and the composite wallboard is prepared from raw materials. The raw materials comprise in parts by mass: 700 to 800 parts of calcined gypsum powder, 0.1 to 1.0 part of a retarder, 0.3 to 0.5 part of a foaming agent, 50 to 70 parts of inorganic fiber, 600 to 700 parts of water, 200 to 400 parts of a binder, 20 to 30 parts of a hydrophobic agent, 3 to 5 parts of an acid agent, and 3 to 5 parts of a pH regulator.

In some embodiments, the calcined gypsum powder is 700 to 780 parts, the retarder is 0.1 to 0.40 part, the foaming agent is 0.3 to 0.45 part, the inorganic fiber is 50 to 65 parts, the water is 600 to 680 parts, the binder is 200 to 390 parts, the hydrophobic agent is 20 to 24 parts, the acid agent is 3 to 4.5 parts, and the pH regulator is 3.3 to 4.3 parts.

In some embodiments, the calcined gypsum powder is hemihydrate gypsum, and the main component of which is CaSO₄·1/2H₂O; the retarder is a mixture of citric acid and sodium hexametaphosphate in a mass ratio of 1:(0.3 to 0.5); the foaming agent is sodium dodecyl sulfate; the inorganic fiber is ceramic fiber or glass fiber; the binder is a mixture of sodium acrylate, polyvinyl alcohol, and Arabic gum in a mass ratio of 1:(0.5 to 1):(0.5 to 2); the hydrophobic agent is a mixture of vinyltrimethoxysilane, methyltrimethoxysilane, and hexadecyltrimethoxysilane in a mass ratio of 1:(0.2 to 0.5):(0.1 to 0.3); the acid agent is acetic acid; and the pH regulator is sodium carbonate.

The embodiments in the present disclosure also provide a preparation method of the composite wallboard as described above, and the method includes the following steps: preparing raw materials according to the parts by mass as described above; mixing water with the hydrophobic agent and the acid agent, stirring until completely hydrolyzed to obtain a solution, standing the solution, then adding the pH regulator to adjust a pH value of the solution to be neutral, then adding the retarder, adding the inorganic fiber after the retarder is completely dissolved, adding the calcined gypsum powder after the inorganic fiber is uniformly dispersed, stirring, to obtain a slurry, after the slurry is uniform, adding the binder and the foaming agent, and uniformly stirring to obtain a gypsum slurry; placing a plate or wallpaper at the bottom of a mold, pouring part of the gypsum slurry into the mold for a first casting, placing a first board in the part of the gypsum slurry after a first vibrating, and standing to obtain a first semi-finished product; performing a second casting on the first semi-finished product, pouring the remaining gypsum slurry into the mold for the second casting, after a second vibrating, obtaining a second semi-finished product; and standing the second semi-finished product at room temperature until completely hardened, then demolding, and drying to obtain the composite wallboard.

In some embodiments, a time of standing the solution is 18 to 24 h, and the pH value is 7.

In some embodiments, a height of the first casting is 5 to 10 cm; after the first casting, the first vibrating is performed after waiting for 2 to 3 mins, and the first vibrating is performed in conditions that the gypsum slurry is vibrated at a vibration frequency of 10 to 15 Hz for 5 to 10 s, and then vibrated at a vibration frequency of 50 Hz for 3 to 4 s.

In some embodiments, the first board is an aluminum silicate fiber board or a vacuum insulation board; a thickness of the first board is 5 to 10 mm; and a time of the first board being placed in the part of the gypsum slurry for standing is 1 to 2 h.

In some embodiments, a height of the second casting is 10 to 25 cm; after the second casting, the second vibrating is performed after waiting for 2 to 3 mins, and the second vibrating is performed in conditions of vibrating at a vibration frequency of 10 to 15 Hz for 5 to 10 s, and then at a vibration frequency of 50 Hz for 3 to 4 s.

A condition of the drying is drying at a temperature of 40 to 60° C. for 24 to 48 h. The water content of the composite wallboard is controlled below 15%.

The embodiments in the present disclosure further provide a composition for preparing a composite board, the composition comprises the following components in parts by mass: 700to 800 parts of calcined gypsum powder, 0.1 to 1.0 part of a retarder, 0.3 to 0.5 part of a foaming agent, 50 to 70 parts of inorganic fiber, 600 to 700 parts of water, 200 to 400 parts of a binder, 20 to 30 parts of a hydrophobic agent, 3 to 5 parts of an acid agent, and 3 to 5 parts of a pH regulator.

In some embodiments, the composition comprises in parts by mass, 700 to 780 parts of calcined gypsum powder, 0.1 to 0.4 part of a retarder, 0.3 to 0.45 part of a foaming agent, 50 to 65 parts of inorganic fiber, 600 to 680 parts of water, 200 to 390 parts of a binder, 20 to 24 parts of a hydrophobic agent, 3 to 4.5 parts of an acid agent, and 3.3 to 4.3 parts of a pH regulator.

In some embodiments, the calcined gypsum powder is hemihydrate gypsum, and a main component of the hemihydrate gypsum is CaSO₄·1/2H₂O; the retarder is a mixture of citric acid and sodium hexametaphosphate in a mass ratio of 1:(0.3 to 0.5); the foaming agent is sodium dodecyl sulphate; the inorganic fiber is ceramic fiber or glass fiber; the binder is a mixture of sodium acrylate, polyvinyl alcohol, and Arabic gum in a mass ratio of 1:(0.5 to 1):(0.5 to 2); the hydrophobic agent is a mixture of vinyltrimethoxysilane, methyltrimethoxysilane, and hexadecyltrimethoxysilane in a mass ratio of 1:(0.2 to 0.5):(0.1 to 0.3); the acid agent is acetic acid; and the pH regulator is sodium carbonate.

### BRIEF DESCRIPTION OF THE DRAWINGS

FIG. 1 is a schematic structural diagram of a composite wallboard obtained by the preparation method of the embodiments in the present disclosure.

FIG. 2 is a schematic structural diagram of a conventional fireproof wallboard.

FIG. 3 is a flow chart of the preparation method of the composite boards according to some embodiments in the present disclosure.

### DETAILED DESCRIPTION OF THE EMBODIMENTS

In order to better explain the present disclosure, the present disclosure will be described in detail below with reference to the accompanying drawings and specific embodiments for better understanding.

The present disclosure mainly solves the problems that the lightweight partition wall installed by the existing method has low installation efficiency and a complex construction process, and the partition wall has poor fireproofing, thermal insulation, and hydrophobic performance, and potential safety hazards, and provides a composite wallboard and a preparation method thereof. The preparation method of the present disclosure uses gypsum as a matrix, and an aluminum silicate fiber board or a vacuum insulation board as a fireproof and heat-insulating material. By hydrolyzing the hydrophobic agent under acidic conditions and then adding alkaline substance to adjust the pH, the composite wallboard is made hydrophobic as a whole. In the preparation process, the hydrophobic agent is first improved and then other raw materials are added, so that the gypsum matrix has waterproof performance, and meanwhile, a foaming agent is introduced into the gypsum matrix to enhance the thermal insulation performance of the gypsum. At the same time, compared with the conventional wallboard structure with the same thickness, the thermal insulation and fireproof performances of the composite wallboard provided in the present disclosure have been improved.

The present disclosure provides a composite wallboard, and the composite wallboard is prepared from raw materials. The raw materials comprise in parts by mass: 700 to 800 parts of calcined gypsum powder, 0.1 to 1.0 part of a retarder, 0.3 to 0.5 part of a foaming agent, 50 to 70 parts of inorganic fiber, 600 to 700 parts of water, 200 to 400 parts of a binder, 20 to 30 parts of a hydrophobic agent, 3 to 5 parts of an acid agent, and 3 to 5 parts of a pH regulator.

The composite wallboard refers to wall panels that have multiple functions such as fire prevention, heat insulation, hydrophobicity, and decoration.

The raw materials refer to the materials used to prepare the composite wallboard, and may include calcined gypsum powder, retarder, foaming agent, inorganic fiber, water, binder, hydrophobic agent, acid agent, and pH regulator.

The calcined gypsum powder may be hemihydrate gypsum. and the main component of the hemihydrate gypsum is CaSO₄·1/2H₂O. The CaSO₄·1/2H₂O content in the hemihydrate gypsum may be no less than 90%. For example, the CaSO₄·1/2H₂O content in the hemihydrate gypsum may be 92%, 95%, or 97%, etc.

The retarder refers to a chemical additive used to slow the setting of cementitious materials (e.g., gypsum). The retarder may be a mixture of citric acid and sodium hexametaphosphate in a mass ratio of 1:(0.3 to 0.5).

In some embodiments, the retarder may be a mixture of citric acid and sodium hexametaphosphate in a mass ratio of 1:(0.3 to 0.4). The retarder may be a mixture of citric acid and sodium hexametaphosphate in a mass ratio of 1:(0.4 to 0.5). The mass ratio of citric acid to sodium hexametaphosphate in the retarder may be 1:0.3, 1:0.4, or 1:0.5, etc.

The foaming agent refers to a chemical additive that can produce uniform and stable foam to produce porous materials. The foaming agent may be sodium dodecyl sulfate.

The inorganic fiber may be ceramic fiber or glass fiber.

The binder is an additive that bonds two or more materials together through physical or chemical action. The binder may be a mixture of sodium acrylate, polyvinyl alcohol, and Arabic gum in a mass ratio of 1:(0.5 to 1):(0.5 to 2).

In some embodiments, the binder may be a mixture of sodium acrylate, polyvinyl alcohol, and Arabic gum in a mass ratio of 1:(0.6 to 1):(0.5 to 2). The binder may be a mixture of sodium acrylate, polyvinyl alcohol, and Arabic gum in a mass ratio of 1:(0.7 to 1):(0.5 to 2). The binder may be a mixture of sodium acrylate, polyvinyl alcohol, and Arabic gum in a mass ratio of 1:(0.75 to 1):(0.5 to 2). The binder may be a mixture of sodium acrylate, polyvinyl alcohol, and Arabic gum in a mass ratio of 1:(0.8 to 1):(0.5 to 2). The binder may be a mixture of sodium acrylate, polyvinyl alcohol, and Arabic gum in a mass ratio of 1:(0.9 to 1):(0.5 to 2). The binder may be a mixture of sodium acrylate, polyvinyl alcohol, and Arabic gum in a mass ratio of 1:(0.5 to 1):(0.7 to 2). The binder may be a mixture of sodium acrylate, polyvinyl alcohol, and Arabic gum in a mass ratio of 1:(0.5 to 1):(0.9 to 2). The binder may be a mixture of sodium acrylate, polyvinyl alcohol, and Arabic gum in a mass ratio of 1:(0.5 to 1 ):(1 to 2). The binder may be a mixture of sodium acrylate, polyvinyl alcohol, and Arabic gum in a mass ratio of 1:(0.5 to 1):(1.2 to 2). The binder may be a mixture of sodium acrylate, polyvinyl alcohol, and Arabic gum in a mass ratio of 1:(0.5 to 1):(1.4 to 2). The binder may be a mixture of sodium acrylate, polyvinyl alcohol, and Arabic gum in a mass ratio of 1:(0.5 to 1):(1.6 to 2). The binder may be a mixture of sodium acrylate, polyvinyl alcohol, and Arabic gum in a mass ratio of 1:(0.5 to 1):(1.7 to 2). The binder may be a mixture of sodium acrylate, polyvinyl alcohol, and Arabic gum in a mass ratio of 1:(0.5 to 1):(1.8 to 2). The binder may be a mixture of sodium acrylate, polyvinyl alcohol, and Arabic gum in a mass ratio of 1:(0.5 to 1):(1.9 to 2).

In some embodiments, the mass ratio of sodium acrylate, polyvinyl alcohol, and Arabic gum in the binder may be 1:0.5:0.5, 1:0.75:1, 1:0.75:1.5, 1:0.75:1.6, 1:0.75:1.7, 1:0.75:2, 1:0.5:1.6, 1:1:1.6, or 1:1:2, etc.

The hydrophobic agent refers to a chemical substance that makes materials hydrophobic. The hydrophobic agent may be a mixture of vinyltrimethoxysilane, methyltrimethoxysilane, and hexadecyltrimethoxysilane in a mass ratio of 1:(0.2 to 0.5):(0.1 to 0.3).

In some embodiments, the hydrophobic agent may be a mixture of vinyltrimethoxysilane, methyltrimethoxysilane, and hexadecyltrimethoxysilane in a mass ratio of 1:(0.25 to 0.5): (0.1 to 0.3). The hydrophobic agent may be a mixture of vinyltrimethoxysilane, methyltrimethoxysilane, and hexadecyltrimethoxysilane in a mass ratio of 1:(0.3 to 0.5):(0.1 to 0.3). The hydrophobic agent may be a mixture of vinyltrimethoxysilane, methyltrimethoxysilane, and hexadecyltrimethoxysilane in a mass ratio of 1:(0.4 to 0.5):(0.1 to 0.3). The hydrophobic agent may be a mixture of vinyltrimethoxysilane, methyltrimethoxysilane, and hexadecyltrimethoxysilane in a mass ratio of 1:(0.2 to 0.4):(0.1 to 0.3). The hydrophobic agent may be a mixture of vinyltrimethoxysilane, methyltrimethoxysilane, and hexadecyltrimethoxysilane in a mass ratio of 1:(0.2 to 0.3):(0.1 to 0.3). The hydrophobic agent may be a mixture of vinyltrimethoxysilane, methyltrimethoxysilane, and hexadecyltrimethoxysilane in a mass ratio of 1:(0.2 to 0.5):(0.2 to 0.3). The hydrophobic agent may be a mixture of vinyltrimethoxysilane, methyltrimethoxysilane, and hexadecyltrimethoxysilane in a mass ratio of 1:(0.2 to 0.5):(0.1 to 0.2).

In some embodiments, the mass ratio of vinyltrimethoxysilane, methyltrimethoxysilane, and hexadecyltrimethoxysilane in the hydrophobic agent may be 1:0.2:0.1, 1:0.2:0.2, 1:0.2:0.3, 1:0.25:0.1, 1:0.25:0.2, 1:0.25:0.3, 1:0.3:0.2, 1:0.4:0.2, 1:0.5:0.1, 1:0.5:0.2, or 1:0.5:0.3, etc.

The acid agent refers to a substance used to provide an acidic environment. The acid agent may be acetic acid.

The pH regulator is a chemical substance used to adjust the acidity (or pH) of a system. The pH regulator may be sodium carbonate.

In some embodiments, the calcined gypsum powder is 700 to 780 parts, the retarder is 0.1 to 0.40 parts, the foaming agent is 0.3 to 0.45 parts, the inorganic fiber is 50 to 65 parts, the water is 600 to 680 parts, the binder is 200 to 390 parts, the hydrophobic agent is 20 to 24 parts, the acid agent is 3 to 4.5 parts, and the pH regulator is 3.3 to 4.3 parts.

The composite wallboard is prepared from the following components in parts by mass: 700 to 800 parts of calcined gypsum powder, 0.1 to 1.0 part of a retarder, 0.3 to 0.5 part of a foaming agent, 50 to 70 parts of inorganic fiber, 600 to 700 parts of water, 200 to 400 parts of a binder, 20 to 30 parts of a hydrophobic agent, 3 to 5 parts of an acid agent, and 3 to 5 parts of a pH regulator.

The calcined gypsum powder may be 700 to 750 parts. The calcined gypsum powder may be 720 to 800 parts. The calcined gypsum powder may be 720 to 780 parts. The calcined gypsum powder may be 720 to 750 parts. The calcined gypsum powder may be 750 to 780 parts. The calcined gypsum powder may be 700 parts, 750 parts, 780 parts, or 800 parts, etc.

The retarder may be 0.1 to 0.7 parts. The retarder may be 0.1 to 0.2 part. The retarder may be 0.4 to 1 part. The retarder may be 0.7 to 1 part. The retarder may be 0.1 part, 0.4 part, 0.7 part, 0.9 part, 0.98 part, or 1 part, etc.

The foaming agent may be 0.4 to 0.5 part, 0.3 part, 0.4 part, or 0.5 part, etc.

The inorganic fiber may be 60 to 70 parts. The inorganic fiber may be 50 to 60 parts. The inorganic fiber may be 50 parts, 60 parts, or 70 parts, etc.

The water may be 600 to 700 parts. The water may be 650 to 700 parts. The water may be 600 to 650 parts. The water may be 600 parts, 650 parts, or 700 parts, etc.

The binder may be 200 to 600 parts. The binder may be 200 to 550 parts. The binder may be 200 to 500 parts. The binder may be 200 parts, 400 parts, 500 parts, or 600 parts, etc.

The hydrophobic agent may be 20 to 50 parts. The hydrophobic agent may be 20 to 40 parts. The hydrophobic agent may be 20 to 35 parts. The hydrophobic agent may be 20 to 30 parts. The hydrophobic agent may be 20 parts, 30 parts, 33 parts, 35 parts, 40 parts, or 50 parts, etc.

The acid agent may be 3 to 5 parts. The acid agent may be 4 to 5 parts. The acid agent may be 3 parts, 4 parts, or 5 parts, etc.

The pH regulator may be 3 to 5 parts. The pH regulator may be 4 to 5 parts. The pH regulator may be 3 parts, 4 parts, or 5 parts, etc.

For the method of preparing the composite wallboard using the above raw materials, please refer to the relevant description below in this disclosure.

The composite wallboard provided in this disclosure has the advantages of light weight, small thickness, good thermal insulation and fireproofing effect, hydrophobicity of the wallboard as a whole, integration of the decorative layer and the wallboard, easy construction and low installation cost.

The present disclosure further provides a composition for preparing the composite board. The composition comprises the following components in parts by mass: 700 to 800 parts of calcined gypsum powder, 0.1 to 1.0 part of a retarder, 0.3 to 0.5 part of a foaming agent, 50 to 70 parts of inorganic fiber, 600 to 700 parts of water, 200 to 400 parts of a binder, 20 to 30 parts of a hydrophobic agent, 3 to 5 parts of an acid agent, and 3 to 5 parts of a pH regulator.

The composite board refers to panels that have multiple functions such as fire prevention, heat insulation, hydrophobicity and decoration. The composite board may include the composite wallboard.

In some embodiments, the composition comprises in parts by mass, 700 to 780 parts of calcined gypsum powder, 0.1 to 0.4 part of a retarder, 0.3 to 0.45 part of a foaming agent, 50 to 65 parts of inorganic fiber, 600 to 680 parts of water, 200 to 390 parts of a binder, 20 to 24 parts of a hydrophobic agent, 3 to 4.5 parts of an acid agent, and 3.3 to 4.3 parts of a pH regulator.

In some embodiments, the calcined gypsum powder is hemihydrate gypsum, and the main component of the hemihydrate gypsum is CaSO₄·1/2H₂O; the retarder is a mixture of citric acid and sodium hexametaphosphate in a mass ratio of 1:(0.3 to 0.5); the foaming agent is sodium dodecyl sulphate; the inorganic fiber is ceramic fiber or glass fiber; the binder is a mixture of sodium acrylate, polyvinyl alcohol and Arabic gum in a mass ratio of 1:(0.5 to 1):(0.5 to 2); the hydrophobic agent is a mixture of vinyltrimethoxysilane, methyltrimethoxysilane and hexadecyltrimethoxysilane in a mass ratio of 1:(0.2 to 0.5):(0.1 to 0.3); the acid agent is acetic acid; and the pH regulator is sodium carbonate.

For relevant descriptions about calcined gypsum powder, retarder, foaming agent, inorganic fiber, binder, hydrophobic agent, acid agent, pH regulator and their weight parts, please refer to the relevant explanation above in this disclosure.

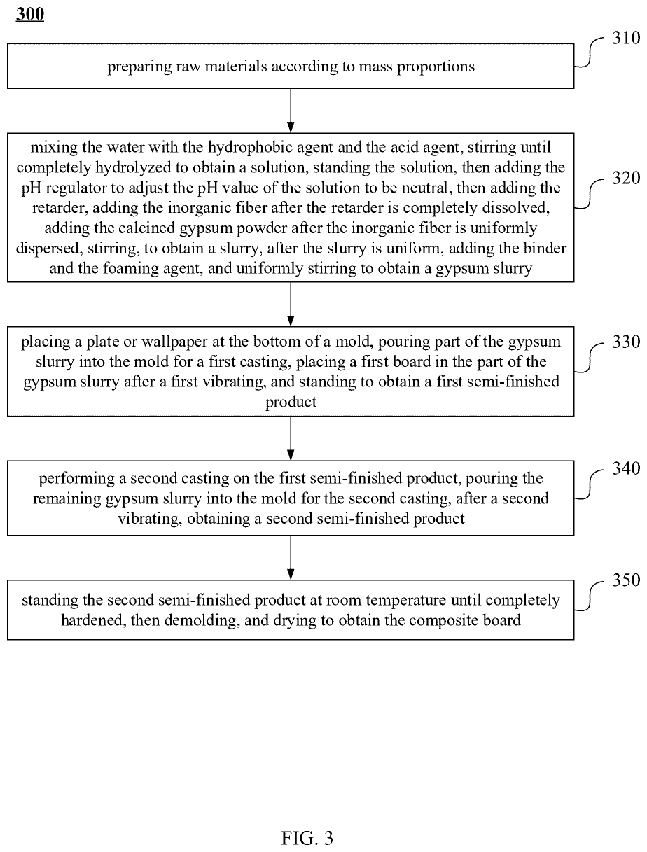

FIG. 3 is a flow chart of the preparation method of the composite boards according to some embodiments of the present disclosure.

The present disclosure further provides a preparation method of the composite board (e.g., composite wallboard), as shown in FIG. 3, process 300 includes the following steps.

S310, preparing raw materials according to mass proportions (i.e., parts by mass).

For relevant descriptions on raw materials and their mass parts, please refer to the relevant explanation above in this disclosure.

S320, mixing the water with the hydrophobic agent and the acid agent, stirring until completely hydrolyzed to obtain a solution, standing the solution, then adding the pH regulator to adjust the pH value of the solution to be neutral, then adding the retarder, adding the inorganic fiber after the retarder is completely dissolved, adding the calcined gypsum powder after the inorganic fiber is uniformly dispersed, stirring, to obtain a slurry, after the slurry is uniform, adding the binder and the foaming agent, and uniformly stirring to obtain a gypsum slurry.

The solution refers to the mixture obtained after dissolving the hydrophobic agent and the acid agent in the water.

The solution may be left standing for 18 to 24 hours (h). The solution may be left standing for 20 to 24 h. The solution may be left standing for 22 to 24 h. The solution may be left standing for 18 h, 20 h, 22 h, or 24 h, etc.

The pH value may be 7.

The slurry refers to the solid-liquid mixture formed by mixing the water, the hydrophobic agent, the acid agent, the pH regulator, the retarder and the inorganic fiber, followed by adding the calcined gypsum powder and subsequent stirring.

The gypsum slurry refers to the mixture obtained by combining raw materials (calcined gypsum powder, retarder, foaming agent, inorganic fiber, water, binder, hydrophobic agent, acid agent, and pH regulator), which may be used for casting.

For relevant descriptions on gypsum powder, retarder, foaming agent, inorganic fiber, binder, hydrophobic agent, acid agent and pH regulator, please refer to the relevant explanation above in this disclosure.

S330, placing a plate or wallpaper at the bottom of a mold, pouring part of the gypsum slurry into the mold for a first casting, placing a first board in the part of the gypsum slurry after a first vibrating, and standing to obtain a first semi-finished product.

The mold is a mold used to prepare a composite board (e.g., a composite wallboard). The size of the mold may be determined according to the size of the composite board (e.g., composite wallboard) to be prepared.

The plate or wallpaper has both waterproof and decorative functions and may also be called waterproof decorative plate or wallpaper. For example, the plate or wallpaper includes PVC plate, metal plate, inorganic pre-coated plate, PVC wallpaper, fiberglass wallpaper, etc.

The first casting refers to pouring part of the gypsum slurry into the mold which has the plate or wallpaper at the bottom.

The first vibrating refers to a vibration on the part of the gypsum slurry in the first casting.

The height of the first casting refers to the height between the upper surface of the part of gypsum slurry poured into the mold and the bottom surface of the mold. For example, the height of the first casting is the height formed by the plate or wallpaper and the part of gypsum slurry in the mold. The height of the first casting may be 5 to 10 cm. The height of the first casting may be 8 to 10 cm. The height of the first casting may be 5 cm, 6 cm, 7 cm, 8 cm, 9 cm, or 10 cm, etc.

After the first casting, the first vibrating is performed after waiting for 2 to 3 mins.

The first vibrating may be performed in conditions that the gypsum slurry is vibrated at a vibration frequency of 10 to 15 Hz for 5 to 10 s, and then vibrated at a vibration frequency of 50 Hz for 3 to 4 s. The first vibrating may be performed in conditions that the gypsum slurry is vibrated at a vibration frequency of 10 to 15 Hz for 5 to 20 s, and then vibrated at a vibration frequency of 50 Hz for 3 to 4 s.

The first board refers to a fireproof, heat-insulating, and surface hydrophobic board. The first board may be an aluminum silicate fiberboard or a vacuum insulation board. The thickness of the first board may be 5 to 10 mm. The thickness of the first board may be 8 to 10 mm. The thickness of the first board may be 5 mm, 6 mm, 7 mm, 8 mm, 9 mm, or 10 mm, etc.

The first board may be left to stand in the part of the gypsum slurry for 1 to 2 h.

The first semi-finished product refers to the intermediate product that has completed the first casting and the first vibrating and has been embedded with the first board, but has not yet undergone the second casting and the second vibrating.

S340, performing a second casting on the first semi-finished product, pouring the remaining gypsum slurry into the mold for the second casting, after a second vibrating, obtaining a second semi-finished product.

The second casting refers to pouring the remaining gypsum slurry on the first semi-finished product.

The second vibrating refers to a vibration on the remaining gypsum slurry in the second casting.

The height of the second casting refers to the height between the upper surface of the remaining gypsum slurry poured into the mold and the bottom surface of the mold. For example, the height of the second casting is the sum of the height of the first casting, the thickness of the first board, and the height of the remaining gypsum slurry formed in the mold, or the height formed by the plate or wallpaper, the part of the gypsum slurry, the first board, and the remaining gypsum slurry in the mold. The height of the second casting may be 10 to 25 cm. The height of the second casting may be 15 to 25 cm. The height of the second casting may be 20 to 25 cm. The height of the second casting may be 10 cm, 15 cm, 20 cm, 22 cm, or 25 cm, etc.

After the second casting, the second vibrating is performed after waiting for 2 to 3 mins.

The second vibrating may be performed in conditions that the remaining gypsum slurry is vibrated at a vibration frequency of 10 to 15 Hz for 5 to 10 s, and then at a vibration frequency of 50 Hz for 3 to 4 s.

The second semi-finished product refers to the intermediate product that has completed two castings (including the first casting and the second casting) and two vibrations (including the first vibrating and the second vibrating).

S350, standing the second semi-finished product at room temperature until completely hardened, then demolding, and drying to obtain the composite board (e.g., the composite wallboard).

The room temperature may be in the range of 15° C. to 30° C.

The condition of the drying is drying at a temperature of 40 to 60° C. for 24 to 48 h.

The composite board (e.g., the composite wallboard) may have a water content below 15%. The composite board (e.g., the composite wallboard) may have a water content below 12%. The composite board (e.g., the composite wallboard) may have a water content below 10%.

For relevant descriptions on the composite board and the composite wallboard, please refer to the relevant explanation above in this disclosure.

According to the preparation method of the composite wallboard provided by the present disclosure, the used raw materials hydrolyze the hydrophobic agent under acidic conditions, and then an alkaline substance is added to adjust the pH in solution, so that the wallboard as a whole has hydrophobicity. The wallboard is prepared using a mold, in the process of preparing the composite wallboard, two vibrations are used to make the closed bubbles evenly distributed. The decorative plate or wallpaper is fixed in the mold, and then integrated with the gypsum by using solidifying and hardening of gypsum. During the preparation process, it is not necessary to use traditional fixing methods such as nailing, thereby eliminating the fireproof weak point of the nail part. The preparation method has the advantages of a simple construction process, high installation efficiency, reduced wall weight, and the like, thereby improving the application effect and stability of the building partition wall.

The embodiments of this disclosure provide a preparation method of a composite board (e.g., composite wallboard), which includes the following steps.

### I. Weighing

First, weighing 700 to 800 parts of calcined gypsum powder, 0.1 to 1.0 part of retarder, 0.3 to 0.5 part of foaming agent, 50 to 70 parts of inorganic fiber, 600 to 700 parts of water, 200 to 400 parts of binder, 20 to 30 parts of hydrophobic agent, 3 to 5 parts of acid agent, and 3 to 5 parts of pH regulator according to mass proportion.

### II. Preparing Gypsum Slurry

Mixing 600 to 700 parts of water with 20 to 30 parts of hydrophobic agent and 3 to 5 parts of acid agent, stirring until completely hydrolyzed to obtain a solution, standing the solution for 24 h, then adding 3 to 5 parts of pH regulator to adjust the solution to pH of 7, then adding 0.1 to 1.0 part of retarder, adding 50 to 70 parts of inorganic fiber after the retarder is completely dissolved, and after the inorganic fiber uniformly dispersed, adding 700 to 800 parts of calcined gypsum powder and stirring to obtain a slurry, after the slurry is uniform, adding 200 to 400 parts of binder and 0.3 to 0.5 part of foaming agent, and uniformly stirring to prepare the gypsum slurry.

### III. Casting, Vibrating, and Compounding

Placing a waterproof decorative plate or wallpaper at the bottom of a mold, pouring the prepared gypsum slurry into the mold to the height of the first casting of 5 to 10 cm, waiting for 2 to 3 mins, vibrating at a vibration frequency of 10 to 15 Hz for 5 to 10 s, then vibrating at a vibration frequency of 50 Hz for 3 to 4 s, then gently placing an aluminum silicate fiber board or a vacuum heat insulation board with fireproofing and heat preservation and surface hydrophobic performances and a thickness of 5 to 10 mm in the gypsum slurry, and waiting for 1 to 2 h to obtain a first semi-finished product.

### IV. Secondary Casting and Vibrating

Performing the second casting on the first semi-finished product, pouring the remaining gypsum slurry into the mold to the height of the second casting of 10 to 25 cm, and after the second casting is completed, waiting for 2 to 3 mins, vibrating at a vibration frequency of 10 to 15 Hz for 5 to 10 s, and then vibrating at a vibration frequency of 50 Hz for 3 to 4 s to obtain a second semi-finished product;

### V. Demolding

The second semi-finished product is left to stand at room temperature until completely hardened, demolded, placed in an oven at 40 to 60° C. for 24 to 48 h, and dried until the water content is lower than 15% to obtain the composite board (e.g., composite wallboard).

In the present disclosure, it has been found through a large number of experimental studies that for the selection of the hydrophobic agent, using a mixture of vinyltrimethoxysilane, methyltrimethoxysilane, and hexadecyltrimethoxysilane could obtain good hydrophobicity. Vinyltrimethoxysilane, methyltrimethoxysilane, and hexadecyltrimethoxysilane exhibit a good hydrophobic effect in a certain ratio of mixed application. Meanwhile, the addition of the acid agent, namely acetic acid, makes vinyltrimethoxysilane, methyltrimethoxysilane, and hexadecyltrimethoxysilane better hydrolyzed. Poor hydrophobicity will cause the board to absorb moisture when placed at a relatively humid place, resulting in a decrease in the overall mechanical properties and heat transfer coefficient of the integrated board. In the dihydrate gypsum and the hemihydrate gypsum, the hemihydrate gypsum is selected as the calcined gypsum powder, the exothermic effect of hemihydrate gypsum is faster than that of dihydrate gypsum, a certain amount of heat can be provided for its own foaming within a short time, and the amount is 700 to 800 parts, too much or too little will affect the foaming effect, so the amount of hemihydrate gypsum is 700 to 800 parts, most preferably 700 to 780 parts.

In the preparation method of the present disclosure, the composite wallboard prepared by the low-frequency vibration vibrating step can achieve the effect of uniform dispersion of various components and closed bubbles, so that the stability and the heat conductivity coefficient of the composite wallboard are better.

In order to better understand the above technical solutions, the exemplary embodiments of the present disclosure will be described in more detail below, but it should be understood that the present disclosure may be implemented in various forms and should not be limited by the embodiments set forth herein. Rather, these embodiments are provided so that the present disclosure can be understood more clearly and thoroughly, and the scope of the present disclosure can be completely conveyed to those skilled in the art.

### EXAMPLE 1

The present example provides a preparation method of the composite board, comprising the following steps.

### S1, Weighing

First, weighing 750 parts of hemihydrate gypsum, 0.5 part of citric acid, 0.2 part of sodium hexametaphosphate, 0.4 part of sodium dodecyl sulfate, 60 parts of ceramic fiber, 650 parts of water, 100 parts of sodium acrylate, 100 parts of polyvinyl alcohol, 200 parts of Arabic gum, 20 parts of vinyltrimethoxysilane, 5 parts of methyltrimethoxysilane, 4 parts of hexadecyltrimethoxysilane, 4 parts of acetic acid, and 4 parts of sodium carbonate according to mass proportions.

### S2, Preparing Gypsum Slurry

Mixing 650 parts of water with a hydrophobic agent (i.e. 20 parts of vinyltrimethoxysilane, 5 parts of methyltrimethoxysilane, 4 parts of hexadecyltrimethoxysilane) and 4 parts of acetic acid, stirring until completely hydrolyzed to obtain a solution, standing the solution for 24 h, then adding 4 parts of sodium carbonate to adjust the solution to pH of 7, then adding a retarder (i.e. 0.5 part of citric acid and 0.2 part of sodium hexametaphosphate), adding 60 parts of ceramic fiber after the retarder was completely dissolved, after the ceramic fiber was uniformly dispersed, adding 750 parts of semi-hydrated gypsum, stirring to obtain a slurry, after the slurry was uniform, adding 100 parts of sodium acrylate, 100 parts of polyvinyl alcohol, 200 parts of Arabic gum, and 0.4 part of sodium dodecyl sulfate, and uniformly stirring to prepare gypsum slurry.

### S3, Casting, Vibrating, and Compounding

Placing a waterproof decorative plate or wallpaper at the bottom of a mold, pouring the prepared gypsum slurry into the mold to the height of the first casting of 10 cm, waiting for 3 mins, vibrating at a vibration frequency of 15 Hz for 10 s, then vibrating at a vibration frequency of 50 Hz for 4 s, gently placing an aluminum silicate fiber board with fireproofing and heat preservation and surface hydrophobic performances and a thickness of 8 mm in the gypsum slurry, and waiting for 2 h to obtain a first semi-finished product.

### S4, Secondary Casting and Vibrating

Performing the second casting on the first semi-finished product, pouring the remaining gypsum slurry into the mold to the height of the second casting of 20 cm, after the second casting was completed, waiting for 3 mins, vibrating at a vibration frequency of 15 Hz for 10 s, and then vibrating at a vibration frequency of 50 Hz for 4 s to obtain a second semi-finished product.

### S5, Demolding

The second semi-finished product was left to stand at room temperature until completely hardened, demolded, placed in an oven at 60° C. for 24 h, and excess water was dried to obtain the composite board (e.g., composite wallboard).

### EXAMPLE 2

The present example provides a preparation method of the composite board, comprising the following steps.

### S1, Weighing

First, weighing 800 parts of hemihydrate gypsum, 0.7 part of citric acid, 0.28 part of sodium hexametaphosphate, 0.5 part of sodium dodecyl sulfate, 60 parts of glass fiber, 700 parts of water, 150 parts of sodium acrylate, 113 parts of polyvinyl alcohol, 250 parts of Arabic gum, 25 parts of vinyltrimethoxysilane, 5 parts of methyltrimethoxysilane, 2.5 parts of hexadecyltrimethoxysilane, 5 parts of acetic acid, and 5 parts of sodium carbonate according to mass proportions.

### S2, Preparing Gypsum Slurry

Mixing 700 parts of water with 25 parts of vinyltrimethoxysilane, 5 parts of methyltrimethoxysilane, 2.5 parts of hexadecyltrimethoxysilane and 5 parts of acetic acid, stirring until completely hydrolyzed to obtain a solution, standing the solution for 24 h, then adding 5 parts of sodium carbonate to adjust the solution to pH of 7, then adding a retarder (i.e. 0.7 part of citric acid and 0.28 part of sodium hexametaphosphate), adding 60 parts of glass fiber after the retarder was completely dissolved, after the glass fiber was uniformly dispersed, adding 800 parts of semi-hydrated gypsum, stirring to obtain a slurry, after the slurry was uniform, adding 150 parts of sodium acrylate, 113 parts of polyvinyl alcohol, 250 parts of Arabic gum, and 0.5 part of sodium dodecyl sulfate, and uniformly stirring to prepare the gypsum slurry.

### S3, Casting, Vibrating, and Compounding

Placing a waterproof decorative plate or wallpaper at the bottom of a mold, pouring the prepared gypsum slurry into the mold to the height of the first casting of 8 cm, waiting for 2 mins, vibrating at a vibration frequency of 10 Hz for 18 s, then vibrating at a vibration frequency of 50 Hz for 3 s, gently placing a vacuum heat insulating board with fireproofing and heat preservation and surface hydrophobic performances and a thickness of 10 mm in the gypsum slurry, and waiting for 2 h to obtain a first semi-finished product.

### S4, Secondary Casting and Vibrating

Performing the second casting on the first semi-finished product, pouring the remaining gypsum slurry into the mold to the height of the second casting of 22 cm, after the second casting was completed, waiting for 2 mins, vibrating at a vibration frequency of 10 Hz for 8 s, and then vibrating at a vibration frequency of 50 Hz for 4 s to obtain a second semi-finished product.

### S5, Demolding

The second semi-finished product was left to stand at room temperature until completely hardened, demolded, placed in an oven at 40° C. for 48 h, and excess water was dried to obtain the composite board (e.g., composite wallboard).

The composite wallboards prepared in the present disclosure have the following performance.

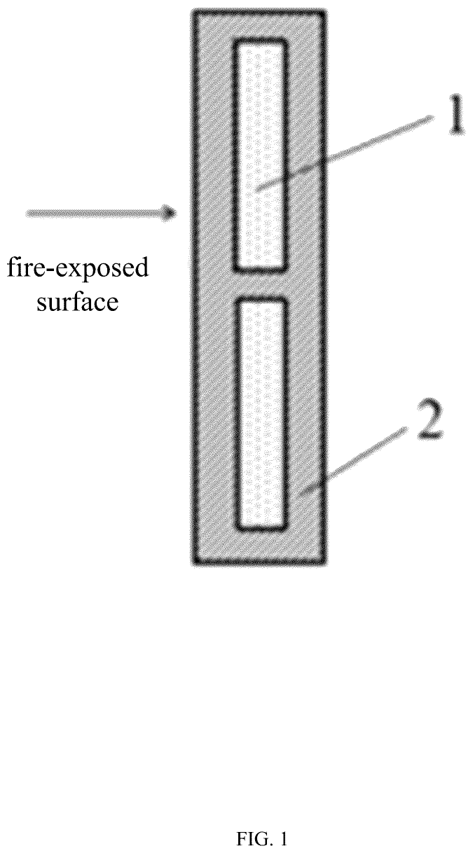

FIG. 1 is a schematic structural diagram of a composite wallboard obtained by the preparation method of the embodiments in the present disclosure.

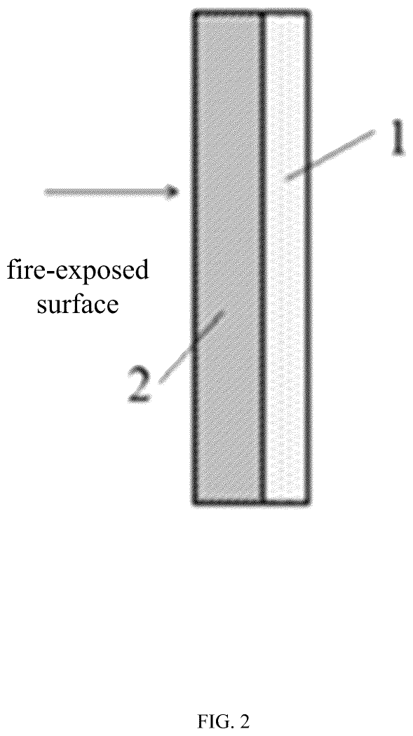

FIG. 2 is a schematic structural diagram of a conventional fireproof wallboard.
1. The fireproof effect: the structure of the composite wallboard prepared by the present disclosure is shown in FIG. 1, a fireproof board 1 is wrapped around the periphery with a modified gypsum board 2, which is equivalent to the traditional structure of gypsum board, the fireproof insulation board, and the gypsum board. After integration, the traditional nailing method is cancelled, and the fireproof weak point at the nail position is eliminated. Meanwhile, the moisture generated during the combustion process of the gypsum board achieves a flame-retardant effect, and the fireproof performance of the integrated wallboard is greatly improved. The conventional wallboard structure is shown in FIG. 2. According to the test method of the fireproof test (BS476: Part 22) of building materials and structures, the tested fireproof limit of the composite wallboard prepared according to Example 1 can reach 3 h 15 mins, and the tested fireproof limit of the composite wallboard prepared according to Example 2 can reach 2 h 45 mins.
2. The heat-insulating effect: the vibrating stage of the composite wallboard makes the closed bubbles in the gypsum board uniformly distributed inside the wallboard, and the closed and uniform bubbles also greatly improve the thermal insulation performance of the wallboard. According to the GB/T 34342 test method, the tested heat transfer coefficient of the composite wallboard prepared according to Example 1 is 0.35 W/(m²·K), and the tested heat transfer coefficient of the composite wallboard prepared according to Example 2 is 0.4 W/(m²·K).
3. Hydrophobicity and Decorativeness: the hydrophobic agent is hydrolyzed under acidic conditions, and then the solution is adjusted in pH to be neutral and added into the gypsum slurry, so that the wallboard as a whole has hydrophobicity; and the decorative layer is integrated with the wallboard, so that the construction is convenient, and the installation cost is reduced.

### Comparative Example 1

The difference between this comparative example and Example 1 is that the hydrophobic agent is only vinyltrimethoxysilane, does not contain methyltrimethoxysilane and hexadecyltrimethoxysilane.

### Comparative Example 2

The difference between this comparative example and Example 2 is that the hydrophobic agent is vinyltrimethoxysilane, and does not contain methyltrimethoxysilane and hexadecyltrimethoxysilane; the binder only uses sodium acrylate, and does not contain polyvinyl alcohol and Arabic gum.

### Comparative Example 3

The difference between this comparative example and Example 1 is that the hydrophobic agent is vinyltrimethoxysilane and methyltrimethoxysilane, and does not contain hexadecyltrimethoxysilane; and the binder is polyvinyl alcohol and Arabic gum, and does not contain sodium acrylate.

According to the test methods of Building Materials and Structures Fire Test (BS 476: Part22) and Enclosure Structure Heat Transfer Coefficient Test (GB/T34342), the fireproof limit of the composite wallboard obtained in Comparative Example 1 is measured to be 1 h 5 mins, and the heat transfer coefficient is 0.95 W/(m²·K); the fireproof limit of the composite wallboard obtained in Comparative Example 2 is 45 mins, and the heat transfer coefficient is 0.8 W/(m²·K); and the fireproof limit of the composite wallboard obtained in Comparative Example 3 is 1 h 25 mins, and the heat transfer coefficient is 0.67 W/(m²·K).

The composite board prepared in the above examples of the present disclosure can meet the requirements of the industry standard of the People's Republic of China “Technical Specification for Application of Thermal Insulated Fireproof Composite Panels” JGJ/T 350-2015 in terms of mechanical properties; it can also be seen from the above test results that the composite board is excellent in heat preservation and fireproofing performances, can be applied to partition walls with high fireproofing requirements, and can also be applied to internal thermal insulation layers of outer walls of building enclosure structures and external thermal insulation layers of outer walls.

In addition, in Comparative Example 1, the hydrophobic agent used is vinyltrimethoxysilane only, which results in a serious decrease in hydrophobic performance and a greatly weakened thermal insulation effect, it can be seen that the use of a single type of hydrophobic agent makes the overall durability of the integrated board poor, so that the time to reach the fireproof limit becomes shorter. In Comparative Example 2, a single hydrophobic agent and a binder are used, the inorganic fiber used is glass fiber, and the temperature resistance limit of the glass fiber itself is lower than that of the ceramic fiber, so that the fireproof limit of Comparative Example 2 is reduced; a single hydrophobic agent and a single binder also lead to a decrease in the hydrophobic performance and bonding capacity of the integrated board, an increase in the heat transfer coefficient, and a deterioration in the insulation effect. In Comparative Example 3, the two-component hydrophobic agent and binder are used, respectively, but the effect is poor compared to Example 1. It can be seen that the preparation method of the composite wallboard provided by the present disclosure greatly improves the overall thermal insulation, hydrophobic properties, and fireproof performance of the composite wallboard, and does not need to use conventional fixing methods such as nailing during the preparation process, thereby eliminating the fireproof weak points at the nail position.

Finally, it should be noted that the above embodiments are only used to illustrate the technical solutions of the present disclosure and are not limited thereto; although the present disclosure is described in detail with reference to the foregoing embodiments, a person of ordinary skill in the art should understand that the technical solutions described in the foregoing embodiments may still be modified, or some or all of the technical features may be equivalently replaced; and these modifications or replacements do not make the essence of the corresponding technical solutions separate from the scope of the technical solutions of the embodiments of the present disclosure.

1. A composite wallboard, wherein the composite wallboard is prepared from raw materials, wherein the raw materials comprise in parts by mass: 700 to 780 parts of calcined gypsum powder, 0.1 to 0.40 part of a retarder, 0.3 to 0.45 part of a foaming agent, 50 to 65 parts of inorganic fiber, 600 to 680 parts of water, 200 to 390 parts of a binder, 20 to 24 parts of a hydrophobic agent, 3 to 4.5 parts of an acid agent, and 3.3 to 4.3 parts of a pH regulator;
wherein the retarder is a mixture of citric acid and sodium hexametaphosphate in a mass ratio of 1:(0.3 to 0.5); the foaming agent is sodium dodecyl sulfate; the inorganic fiber is ceramic fiber or glass fiber; and the hydrophobic agent is a mixture of vinyltrimethoxysilane, methyltrimethoxysilane, and hexadecyltrimethoxysilane in a mass ratio of 1:(0.2 to 0.5):(0.1 to 0.3);
wherein the composite wallboard is prepared by a process including:
preparing the raw materials according to the parts by mass;
mixing the water with the hydrophobic agent and the acid agent, stirring until completely hydrolyzed to obtain a solution, standing the solution, then adding the pH regulator to adjust a pH value of the solution to be neutral, then adding the retarder, adding the inorganic fiber after the retarder is completely dissolved, adding the calcined gypsum powder after the inorganic fiber is uniformly dispersed, stirring to obtain a slurry, adding the binder and the foaming agent after the slurry is uniform, and uniformly stirring to obtain a gypsum slurry;
placing a plate or wallpaper at a bottom of a mold, pouring part of the gypsum slurry into the mold for a first casting, placing a first board in the part of the gypsum slurry after a first vibrating, and standing to obtain a first semi-finished product;
performing a second casting on the first semi-finished product, pouring the remaining gypsum slurry into the mold for the second casting, after a second vibrating, obtaining a second semi-finished product, wherein the second vibrating is performed in conditions of vibrating at a vibration frequency of 10 to 15 Hz for 5 to 10 s, and then at a vibration frequency of 50 Hz for 3 to 4 s; and
standing the second semi-finished product at room temperature until completely hardened, then demolding, and drying to obtain the composite wallboard.

2. (canceled)

3. The composite wallboard according to claim 1, wherein the calcined gypsum powder is hemihydrate gypsum, and a main component of the hemihydrate gypsum is CaSO₄·1/2H₂O;
the binder is a mixture of sodium acrylate, polyvinyl alcohol, and Arabic gum in a mass ratio of 1:(0.5 to 1):(0.5 to 2);
the acid agent is acetic acid; and
the pH regulator is sodium carbonate.

4. (canceled)

5. The composite wallboard according to claim 1, wherein a time of standing the solution is 18 to 24 h, and the pH value is 7.

6. The composite wallboard according to claim 1, wherein a height of the first casting is 5 to 10 cm, after the first casting, the first vibrating is performed after waiting for 2 to 3 mins, and the first vibrating is performed in conditions that the gypsum slurry is vibrated at a vibration frequency of 10 to 15 Hz for 5 to 10 s, and then vibrated at a vibration frequency of 50 Hz for 3 to 4 s.

7. The composite wallboard according to claim 1, wherein the first board is an aluminum silicate fiber board or a vacuum insulation board; a thickness of the first board is 5 to 10 mm; and a time of the first board being placed in the part of the gypsum slurry for standing is 1 to 2 h.

8. The composite wallboard according to claim 1, wherein a height of the second casting is 10 to 25 cm, after the second casting, the second vibrating is performed after waiting for 2 to 3 mins; and a condition of the drying is drying at a temperature of 40 to 60°C for 24 to 48 h.

9. A composition for preparing a composite board, wherein the composition comprises the following components in parts by mass: 700 to 780 parts of calcined gypsum powder, 0.1 to 0.40 part of a retarder, 0.3 to 0.45 part of a foaming agent, 50 to 65 parts of inorganic fiber, 600 to 680 parts of water, 200 to 390 parts of a binder, 20 to 24 parts of a hydrophobic agent, 3 to 4.5 parts of an acid agent, and 3.3 to 4.3 parts of a pH regulator;
wherein the calcined gypsum powder is hemihydrate gypsum, and a main component of the hemihydrate gypsum is CaSO₄·1/2H₂O; the retarder is a mixture of citric acid and sodium hexametaphosphate in a mass ratio of 1:(0.3 to 0.5); the foaming agent is sodium dodecyl sulfate; the inorganic fiber is ceramic fiber or glass fiber; the binder is a mixture of sodium acrylate, polyvinyl alcohol, and Arabic gum in a mass ratio of 1:(0.5 to 1):(0.5 to 2); the hydrophobic agent is a mixture of vinyltrimethoxysilane, methyltrimethoxysilane, and hexadecyltrimethoxysilane in a mass ratio of 1:(0.2 to 0.5):(0.1 to 0.3); the acid agent is acetic acid; and the pH regulator is sodium carbonate.

10. (canceled)
